(19) United States
(12) Patent Application Publication
(10) Pub. No.: US 2008/0008292 A1
(43) Pub. Date: Jan. 10, 2008

(54) X-RAY SCATTERING BONE DENSITOMETER AND METHOD OF USE

(76) Inventors: Miodrag Krmar, Novi Sad (YU); George Ma, Irvine, CA (US); Kenneth Ganezer, Los Angeles, CA (US)

Correspondence Address: PERKINS COIE LLP, POST OFFICE BOX 1208, SEATTLE, WA, 98111-1208, US

(21) Appl. No.: 11/744,181

(22) Filed: May 3, 2007

Related U.S. Application Data
(60) Provisional application No. 60/746,463, filed on May 4, 2006.

(51) Int. Cl. G01B 15/02

(52) U.S. Cl. 378/89

(57) ABSTRACT

In an embodiment of the invention, a method of measuring bone density is provided comprising: irradiating a volume to be analyzed; for x-rays emerging from the irradiated volume, detecting at least two of transmitted x-rays, forward scattered x-rays and backward scattered x-rays; and analyzing at least two of the transmitted x-rays, the forward scattered x-rays, or the backward scattered x-rays to determine a density by determining at least one of a ratio of the forward scattered x-rays to the backward scattered x-rays, a ratio of the forward scattered x-rays to the transmitted x-rays, or the product of the ratio of the forward scattered x-rays to the backward scattered x-rays and the ratio of the forward scattered x-rays to the transmitted x-rays.

### CROSS-REFERENCE TO RELATED APPLICATIONS

The present application claims the benefit of U.S. Provisional Patent Application Ser. No. 60/746,463, filed May 4, 2006, which is incorporated herein by reference in its entirety.

### FIELD OF THE INVENTION

The present invention relates to bone densitometry.

### BACKGROUND OF THE INVENTION

Osteoporosis is a common, silent, and complex bone disease which poses a major health threat to our aging population [1, 2]. The disease state of osteoporosis is characterized by low bone mass, leading to enhanced bone fragility and a significantly increase in the risk of fractures that are due to low bone mass. Fracture, a standard clinical manifestation of osteoporosis, depends on bone mass and bone quality, but bone mass as measured by bone mineral density (BMD) is the most important factor in determining bone strength and fracture risk. A low bone mass or osteoporosis can also develop among young adults if their optimal bone peak is not reached during childhood and adolescence.

Despite advances in technology and increased concern among public health officials and the general public, assessing osteoporosis and fracture risk remains a challenge [1-4]. Reproducibility and correlation of measurements by the current diagnostic technologies are imperfect. Clinical BMD data are controversial and difficult to compare for the wide variety of available types of equipment and technologies [5-8].

In addition to the prevention of mortality and morbidity, current bone densitometry modalities focus on improving osteoporosis management through early diagnosis, preventative measures, and monitoring the course of treatment, as outlined in FIG. 2. Using state-of-the-art technology, a lower limit on the precision error in BMD measurement is generally thought by specialists to be 5-6%. The true rate of BMD decrease is thought to be 0.5-2% per year for osteoporotic patients while it is recommended that patients undergoing drug treatment for osteoporosis undergo BMD monitoring every 1 to 2 years, which corresponds to a measured in-vivo rate of BMD decrease of 1-2% per year. As a consequence, an estimated period of 5-10 years is needed in order to measure a significant decrease in BMD of 5-10% [3, 4, and 27]. Diagnostic tools for osteoporosis have yet to be found to provide the highest accuracy and sensitivity [ 1, 2].

Because of the foregoing, it is desirable to develop an improved apparatus and method for measuring bone density.

### SUMMARY OF THE INVENTION

In one embodiment of the invention, a method of measuring bone density is provided comprising: irradiating a volume to be analyzed; for x-rays emerging from the irradiated volume, detecting at least two of transmitted x-rays, forward scattered x-rays and backward scattered x-rays; and analyzing at least two of the transmitted x-rays, the forward scattered x-rays, or the backward scattered x-rays to determine a density by determining at least one of a ratio of the forward scattered x-rays to the backward scattered x-rays, a ratio of the forward scattered x-rays to the transmitted x-rays, or the product of the ratio of the forward scattered x-rays to the backward scattered x-rays and the ratio of the forward scattered x-rays to the transmitted x-rays.

In another embodiment of the invention a method of measuring bone density is provided comprising: irradiating a volume to be analyzed; for x-rays emerging from the irradiated volume, detecting at least two of transmitted x-rays, forward scattered x-rays and backward scattered x-rays; and analyzing at least two of the transmitted x-rays, the forward scattered x-rays, or the backward scattered x-rays to determine a density by normalizing the intensity of the forward scattered x-rays and the backward scattered x-rays.

In another embodiment of the invention A method for attenuation compensation comprising: (1) irradiating a volume to be analyzed with first incident beam; (2) for x-rays emerging from the irradiated volume, detecting at least two of transmitted x-rays, forward scattered x-rays at an angle θ from the transmitted x-rays and backward scattered x-rays at an angle θ plus about 180° from the transmitted x-rays; (3) analyzing at least two of the transmitted x-rays, the forward scattered x-rays, or the backward scattered x-rays to determine a bone mineral density by determining at least one of a ratio of the forward scattered x-rays to the backward scattered x-rays, a ratio of the forward scattered x-rays to the transmitted x-rays, or the product of the ratio of the forward scattered x-rays to the backward scattered x-rays and the ratio of the forward scattered x-rays to the transmitted x-rays; (4) irradiating the volume to be analyzed with a second incident beam wherein the second incident beam is 180° from the first incident beam, and/or irradiating the volume to be analyzed with a third incident beam wherein the third incident beam is 180° plus or minus angle θ from the first incident beam; and (5) repeating steps (2) and (3) for the second incident beam and/or the third incident beam.

### BRIEF DESCRIPTION OF THE DRAWINGS

FIG. 1 shows a comparison of conventional CCSR and some embodiments of the present invention.

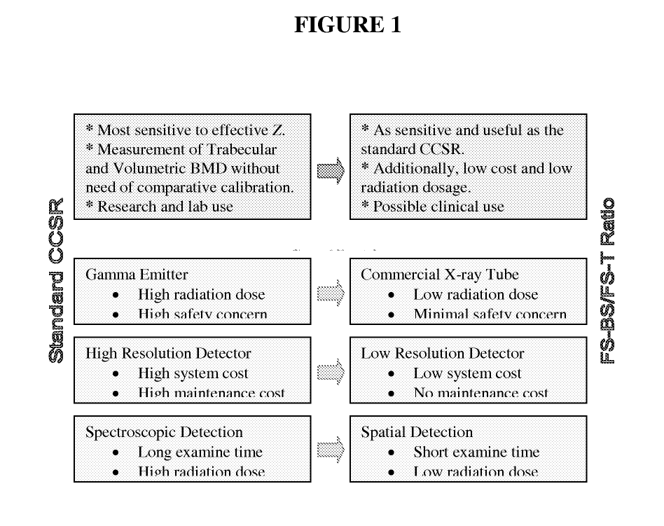

FIG. 2 shows an example of osteoporosis management.

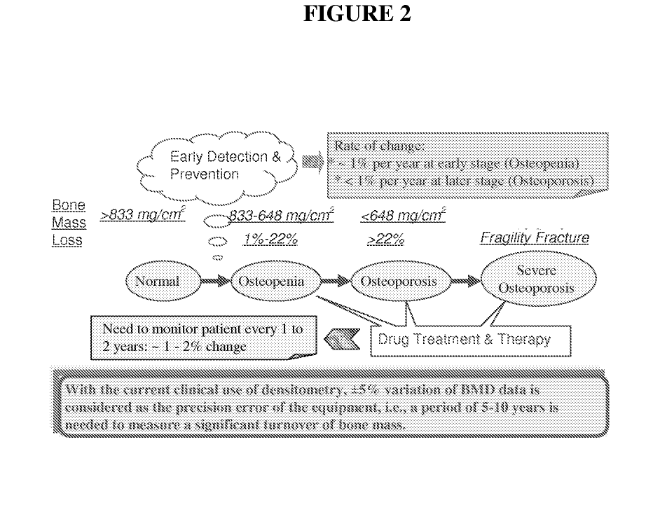

FIG. 3 shows the dependence of CCSR_{(Z=12})/CCSR(Z₌₇) on θ for an incident energy of 60 keV.

FIG. 4 shows the geometry of the region of interest (ROI).

FIG. 5 shows the relative intensity of scattering components.

FIG. 6 shows calculated R_{FS/BS}vs. Z and Scattering Angle (θ).

FIG. 7 shows the R_{FS/BS} measurement setup.

FIG. 8 shows the spectra of x-ray radiation scattered at 15° and 90°.

FIG. 9 shows R_{FS/BS} as a function of density.

FIG. 10 shows the ratio R_{FS/T} vs. atomic number for scattering angles (in degree).

FIG. 11 shows the experimental setup for measurement of transmitted and scattered radiations at 15 Degree.

FIG. 12 shows R_{FT} v. density.

FIG. 13 shows the product of R_{FB} and R_{FT} vs. density.

FIG. 14 shows an experimental setup of forward-backward/forward-transmitted radiations.

FIG. 15 shows a design for annular FS-BS/FS-T scattering and dual energy absorption detections.

FIG. 16 shows an attenuation correction method.

FIG. 17 shows the experiment design of the attenuation study.

FIG. 18 shows a diagnostics system.

### DETAILED DESCRIPTION

In order to fully understand the manner in which the above-recited details and other advantages and objects according to the invention are obtained, a more detailed description of the invention will be rendered by reference to specific embodiments thereof.

In one embodiment of the invention a new diagnostic technique of measuring bone mineral density (BMD) for diagnosing and monitoring the course of treatment (assessment) of osteoporosis and other bone diseases is described. The simple and robust techniques of small-angle forward-to-backward scattering (FS-BS) and small angle forward scattering-to-transmitted radiation (FS-T), based on the use of the Coherent to Compton Scattering Ratio (CCSR), can offer a high quality in-vivo measurement of BMD by overcoming prior CCSR limitations, such as high radiation dosage, high system cost and long examination time. Among bone diagnostic technologies, CCSR is considered to be a superior and most sensitive method for BMD determination without the need for a case-by-case calibration. It also has several advantages over the current gold standard technology, Dual-Energy X-ray Absorptiometry (DEXA). CCSR is unique in that it provides a quantitative and direct determination of volumetric BMD (in mg/cm3), the “true” density, while the areal BMD (in mg/cm2) that is obtained from DEXA, yields at best a highly uncertain estimate of the true density. Another important advantage of CCSR is that it has been accurately applied to trabecular bone in-vivo to yield Trabecular Bone Mineral Density (TBMD) which can be difficult to isolate from cortical bone in many applications of DEXA. Since trabecular bone is the most metabolically active component of the skeleton and can limit bone strength in serious fractures such as those of the hip and spine, the determination of volumetric TBMD is crucial for diagnosing and monitoring the course of treatment of osteoporosis and other metabolic bone diseases. Despite the potential and promise of CCSR, it has only been applied in-vivo to the calcaneous using an obsolete configuration and cryogenically cooled detectors. The present embodiment provides a CCSR-based method and device that is not only highly sensitive and accurate, but also clinically practical and useful to meet the current and future demands of osteoporosis assessment and management.

The CCSR technique has great potential and promise to be broadly applied in bone diagnostics [9, 35, 37-51]. The intensity ratio of coherent and Compton scattered radiation is a strong function of the effective atomic number Z_{eff} of the scattering medium. Specifically it implements a higher order function of bone mineral density (Eqs. 1-3) compared to the approximately 1^{st} order (linear) dependence on Z_{eff} of absorption and transmission based technology, such as DEXA and QCT. Specifically, CCSR can quantitatively determine volumetric bone mass without the need for a comparative calibration. Consequently, a significant source of uncertainty, the large pool of human data used by other radiological methods, can be circumvented. The CCSR technique is also capable of isolating trabecular bone from cortical bone and selecting a localized region of bone to test for BMD determination. Even though CCSR is considered to be the most sensitive measure of BMD, it has only been tested in small feasibility trials and never in clinical practice because of the limitations of the conventional technique. The coherent and Compton peaks, separated by a small energy difference of a couple of keV, are generated using a single gamma line from a long-lived high-activity radionuclide source. A narrow low-statistics coherent peak must be resolved from the broad high-statistics spectrum of Compton scattered photons using an expensive high-resolution Ge detector operating at the cryogenic temperature of liquid nitrogen (of 92 K). As a result, isolated coherent peak detection requires a long measurement time and high radiation dosage in order to obtain good photon counting statistics for the coherent peak. Although the coherent intensity is much higher at small scattering angles, the Compton and coherent peaks cannot be resolved even with the most sensitive and up to date detectors. In addition, the ²⁴¹Am radioactive source has a high activity within the GBq order of magnitude. ²⁴¹Am, and a half-life of more than 400 years that requires strong safety measures.

In one embodiment two new approaches to x-ray scattering are described, the Forward-to-Backward Scattering (FS-BS) and Forward Scattering-to-Transmission (FS-T) ratios using a diagnostic X-ray tube as a source of radiation, that can yield a simple but high quality measurement of BMD [23]. As one of its distinguishing features from standard CCSR, the present embodiment utilizes the continuous spectrum of an X-ray source despite the fact that Coherent and Compton components can not be separated and both components must be measured together for all scattering angles. After scattering, the energy of the Compton photons is shifted downward by a few keV while the energy of the coherent component is unchanged. The intensity of the coherent and Compton scattered components of the scattered beam are determined from the scattering angle. Typically forward scattered radiation is similar to incident and transmitted radiation and consists mostly of coherently scattered photons (approximately 70-80%) but backward scattered radiation is dominated by its Compton component (approximately 99% or larger). Since our ratios are independent of the intensity of incident radiation, unlike DEXA, a reference calibration is not required for a quantitative bone assessment. In the present embodiment it is only necessary to select optimal spectral segments that give greatest sensitivity to BMD in the region of interest rather than the most sensitive X-ray detectors. Therefore a relatively low cost and low resolution spectroscopic detector is all that is needed for good results, rather than a high resolution HPGe detector. Since the intensity of forward scattered coherent radiation is more than 100 times stronger than large angle coherent scattering use of the continuous and broader energy bandwidth of coherent radiation in our method, improves photon counting statistics and can shorten measurement time and lower radiation dosage.

In particular, the FS-BS/FS-T ratio bone methods are safe and yield a system cost that is low compared to that of standard CCSR. The geometrical configuration of the present embodiment makes multiple simultaneous measurements simple and robust. Further, dual-energy transmission detectors can be used.

A technique for measuring bone mineral density was is described by Puumalainen [35] using scattered radiation from a well-defined volume element (voxel) of trabecular bone. This technique is based on the fact that the intensity ratio of coherent to Compton scattered radiation is strongly dependent on the atomic number of the scattering medium (Z). The intensity ratio of coherent to Compton scattered radiation is proportional to the ratio of total atomic cross sections which can be approximated by the following power laws for coherent [36] and Compton [37] scattering respectively:
σ_{coh}≈C₁Zⁿ/E^{m} (1)
σ_{c}C₂Z (2)

In Eqs. 1 and 2, C₁ and C₂ are constants, Z is the atomic number of the scattering medium, and E is the energy of the incident photons. The value of the exponent m is determined by Z. As expressed, Coherent scattering is an exponential function of Z while Compton scattering is a simple linear function of Z as in x-ray transmission. In order to cancel out all other parameters including the intensity of the incident radiation and other possible normalization factors, the ratios of the total cross-sections given by equations (1) and (2) is taken.

$$\frac{{σ}_{coh}}{{σ}_{C}} = {C}_{3} {Z}^{n - 1} \qquad ( 3 )$$

In the simple case where the intensities are measured in a narrow beam geometry defined by the scattering angle, the coherent to Compton Scattering Ratio (CCSR) can be calculated by taking the ratio of the atomic differential cross sections per unit solid angle as follows:

$$CCSR = \frac{ⅆ {σ}_{coh}}{ⅆ Ω} / \frac{ⅆ {σ}_{C}}{ⅆ Ω} = \frac{{[ 1 + k ( 1 - cos θ ) ]}^{2} {( 1 + {cos }^{2} θ ) [ F ( x , Z ) ]}^{2}}{\{ 1 + {cos}^{2} θ + [ {{k}^{2} ( 1 - cos θ )}^{2} ] / [ 1 + k ( 1 - cos θ ) ] \} S ( x , Z )} \qquad ( 4 )$$

Where k—is the photon energy in units of electron rest mass energy

θ—is the scattering angle

F(x, Z)—is the atomic form factor for coherent scattering

S(x, Z)—is the incoherent (Compton) scattering function

x—is the momentum transfer variable given by

$$x = \frac{1}{λ} sin \frac{θ}{2} \qquad ( 5 )$$

and λ is the wavelength of incident radiation (in Å units). Using the tabulated values [38], the ratio of F(x, Z) and S(x, Z) can be described by a Zⁿ⁻¹ power law.

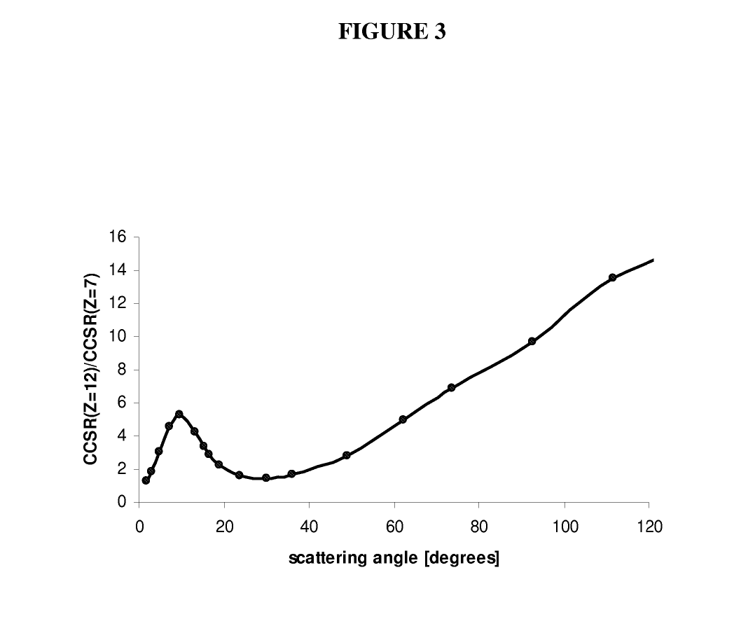

The value of the exponent n varies with photon energy and scattering angle. If a radionuclide source such as ²⁴¹Am (with a single narrow spectral line that produces an incident photon of energy of 59.5 keV) is used as to generate photons, n varies from 1.97 for a scattering angle (θ) of 22.5° to 5.50 for θ=135° [39]. Thus the sensitivity of the CCSR method improves with scattering angle. The maximum value of θ in previous CCSR studies is 135° [40] since at larger values of θ the intensity of the coherent component of the beam drops off precipitously and becomes too small to be discernable from the Compton scattered photons. To obtain a measure of the sensitivity of the rpesent embodiment the ratio of the quantity CCSR defined by Eq. 4 calculated at Z=12 to that at Z=7 (CCSR_{(Z=12)}/CCSR_{(Z=7)})has been plotted in FIG. 3 as a function of scattering angle (θ) for 2°≦θ≦112° and a fixed incident energy of 60 keV. This sensitivity ratio (CCSR_{(Z=}₁₂₎/CCSR_{(Z=7)}) increases nearly linearly from 30° to 120° with a small peak located at around 12°. When the atomic number falls between 7 and 12, the location of the peaks is also a function of the incident energy but the amplitude of the peak does not vary with energy. The angle of peak sensitivity is found to be about 18° for 40 keV, 12° for 60 keV, and less than 8° for 100 keV. One goal of the present embodiment is to obtain the highest sensitivity possible for scattering at small angles by a careful choice of parameters such as θ.

The proportion of coherently scattered radiation is strongly dependent on Z as well (as on θ). The coherent differential cross section (in Eq. 4) increases by a factor of 7 while the Compton differential cross section only increases by 25% as Z increases from 7 to 12. Therefore at high values of Z the coherent component dominates at small values of θ (in the forward direction). In the traditional CCSR setup the coherent and Compton peaks at low values of θ are separated by a very small energy difference. For example, the energy interval between the two peaks for incident energy equal to 60 keV is 0.11 keV at θ=10° and 0.24 keV for θ=15°. In the present embodiment in which a continuous X-ray spectrum is used the coherent and Compton peaks cannot be distinguished, it is appropriate to measure the following integrated intensity:

$${I}_{tot} ( E , Z , θ ) = {I}_{0} NA ɛ ( E ) ( \frac{ⅆ {σ}_{coh}}{ⅆ Ω} + \frac{ⅆ {σ}_{com}}{ⅆ Ω} ) \qquad ( 6 )$$

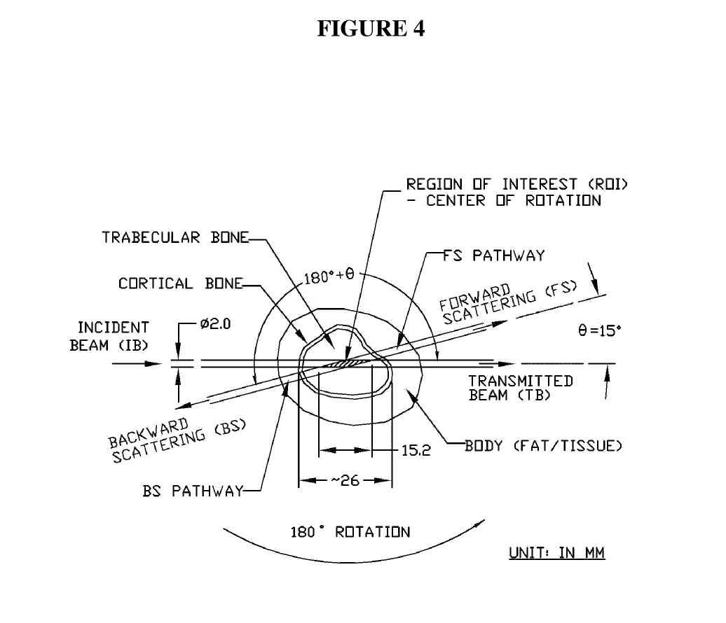

The total intensity including the unresolved coherent and Compton peaks depends upon Z as well as several other parameters such as geometrical specifications, the attenuation properties of the scattering medium and surrounding tissues, and the detector efficiency. To limit the number of variables, several parameters including the intensity of the incident beam are canceled out by taking the following ratios (and effectively normalizing the results): the Forward-to-Backward Scattering Radiation Ratio and the Forward Scattering-to-Transmission Ratio. The geometry of the region of interest (ROI) irradiated by an incident beam is outlined in FIG. 4. In a preliminary study, collimators were selected with small 2 mm to allow the ROI (where the collimators intersect) to be smaller in volume and dimensions than the regions of the body to be studied such as the trabecular regions of the calcaneous and the forearm.

Forward-to-Backward Scattering (FS-BS) Ratio

In another embodiment, the intensity of radiation that is forward scattered (FS) at an angle θ is normalized by the intensity of radiation that is back scattered (BS) at an angle of 180+θ (along the incident ray but propagating in the backward direction). The volume of the medium viewed by two detectors is the same if the FS and BS beams were assumed to be precisely collimated. The axes of the two beams may diverge slightly but this effect can be minimized by using long and narrow collimators which enforce “strong” collimation.

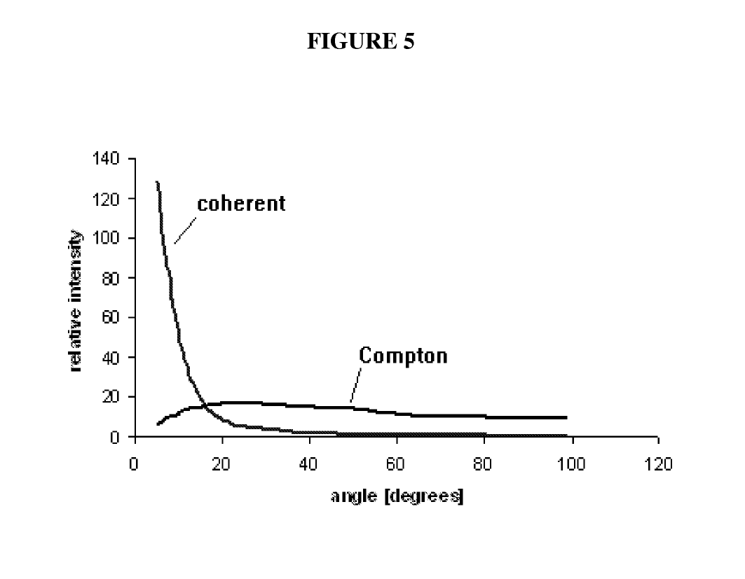

In the backward direction, the intensity of the coherent radiation decreases rapidly as the scattering angle θ is increased. When the atomic number (Z) equals 7, the incident energy (E) is 60 keV and θ=190°, the intensity of the coherent component is only about 0.05% of that of the Compton component. When Z is increased to 12, the coherent proportion increases to 0.8% that of Compton scattering for the same values for the other 2 parameters (E=60 keV and θ=190°). The relative intensities of the coherent and Compton scattered components is plotted versus in FIG. 5 versus θ for these conditions (E=60 keV and θ=190°). FIG. 5 shows that in the backward direction (θ near 180°) the coherent component is negligible. But in the forward direction (θ near 0), the situation is quite different; and the coherent and Compton components are comparable. The intensity ratio of forward scattered to backward scattered radiation is thus given by the following approximate formulas:

$$\begin{matrix}{R}_{FS / BS} = \frac{{I}_{FS} ( Z , θ )}{{I}_{BS} ( Z , 180 + θ )} = \frac{{( {I}_{coh} ( Z , θ ) + {I}_{Com} ( Z , θ ) )}_{FS}}{{( {I}_{Com} ( Z , 180 + θ ) )}_{BS}} = k \cdot a \cdot ( \frac{\frac{ⅆ {σ}_{coh} ( Z , θ )}{ⅆ Ω} + \frac{ⅆ {σ}_{Com} ( Z , θ )}{ⅆ Ω}}{\frac{ⅆ {σ}_{Com} ( Z , 180 + θ )}{ⅆ Ω}} ) & ( 7 ) \\ {R}_{FS / BS} = k \cdot a \cdot M ( Z , θ ) & ( 8 )\end{matrix}$$

where k contains all non-cancelled parameters related to the scattering volume and detector efficiency of the FS and BS scattering radiations, α is the attenuation ratio equal to

$$\frac{{a}_{FS}}{{a}_{BS}} ,$$

and M(Z,θ) is a function of atomic number and scattering angle only. As shown, R_{FB} is a function of three variables; E (incident energy), Z and θ and sets of plots for R_{FB} can be obtained by fixing one variable and varying the other two using equations (7) and (8) and the available data for the corresponding differential cross sections

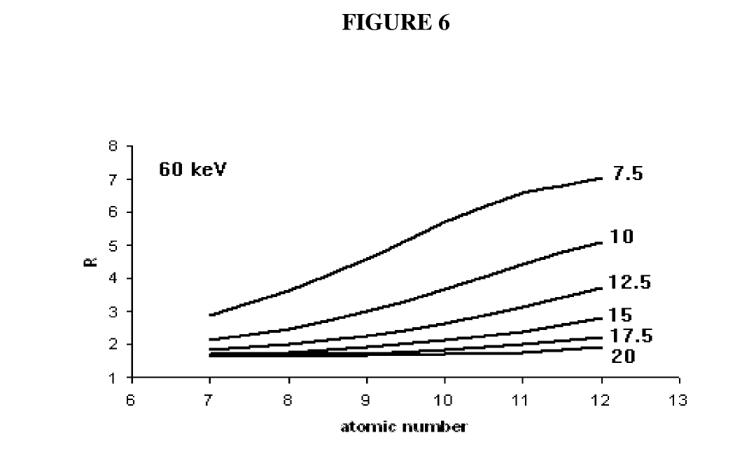

For example FIG. 6 contains curves of R_{FB} as a function of Z for a range of scattering angles and E =60 keV.

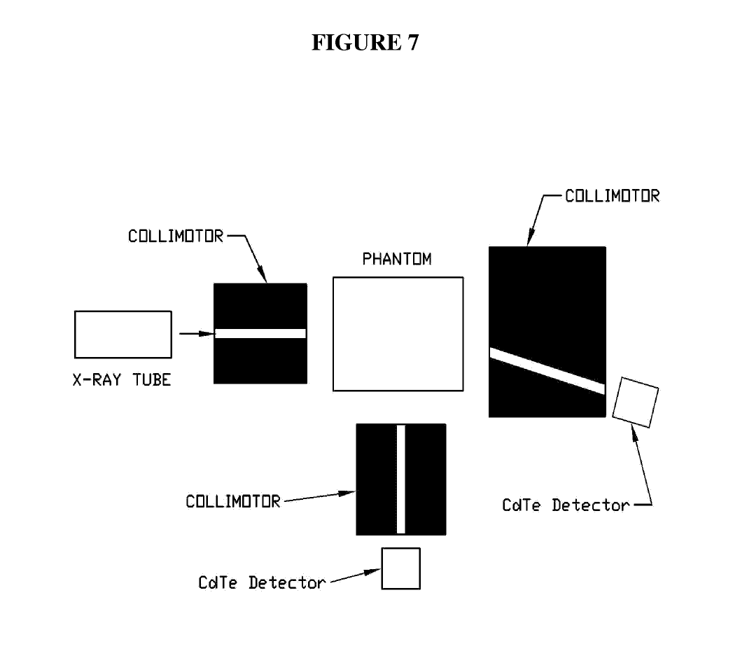

An experimental setup according to the present embodiment is shown in FIG. 7. The intensities of the scattered radiation were measured at θ=15° and θ=90°. The maximum energy of the x-ray tube was 80 keV and spectra were obtained using two CdTe detectors. A set of ten x-ray phantoms designed to simulate the calcaneous with calibrated trabecular bone mineral density (TBMD) ranging from 51.8 to 347.3 mg/Cm³ and covering the range of TBMD found in vivo in healthy osteoporotic and highly osteoporotic human subjects was used as the scattering media in tests of our CCSR methods. These test objects were used to calibrate initial CCSR studies undertaken at the UCLA bone laboratory from 1985-1992 [9].

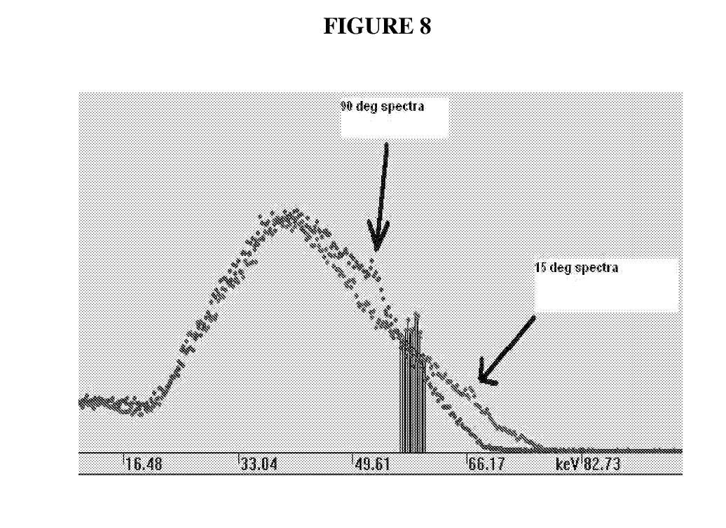

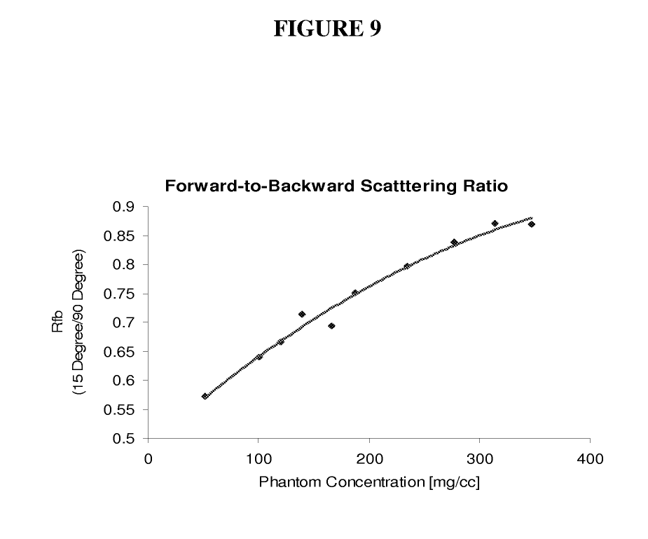

FIG. 8 shows the recorded spectra taken at our θ=15° and θ=90° for the expiremental setup of FIG. 7. The 15° spectrum contains fluorescence lines at the appropriate energies between 55.8 to 60.5 keV from excitation of tungsten in the x-ray target. In Compton scattering, part of the photon energy is transferred to the electrons of medium. This energy shift is a function of the scattering angle (θ) and given by the formula Δλ=λ_{c} (1-cosθ), where Δλ is the corresponding wavelength shift and λ_{c} is the Compton wavelength. For θ=90° photons from the (55.8-60.5 keV) fluorescent line region of the spectrum have their energy lowered to 50.3-54.1 keV. Thus 55.8-60.5 keV photons are selected for FS (15°) and 50.3-54.1 keV photons for 90° BS photons and used to calculate R_{FB}. The 15° scattering intensity was normalized using the 90° intensity. The same procedure was repeated for each of the trabecular bone phantoms. In FIG. 9, measured R_{FB} values are plotted versus the nominal TBMD of the test objects (as points) for each of the 10 phantoms along with a solid curve that is a fit to the ten RFB points.

Forward Scattering to Transmission (FS-T) Ratio

The intensity of small angle forward scattering, properly normalized, can be used to determine Bone Mineral Density (BMD). For small scattering angles, such as θ=15°, transmitted and scattered photons follow similar paths and undergo a similar amount of attenuation, that can be assumed to be approximately equal (as discussed below). All parameters associated with the experimental setup and the attenuation properties of irradiated tissues are cancelled when a ratio is taken. For small θ the ratio of the intensity of forward scattering to transmitted photons (R_{FT}) is proportional to the sum of the coherent and Compton components:

$${R}_{FS / T} = \frac{{I}_{FS} ( Z , θ )}{{I}_{T} ( Z , θ )} = {k}^{′} \cdot {a}^{′} \cdot ( \frac{ⅆ {σ}_{coh} ( Z , θ )}{ⅆ Ω} + \frac{ⅆ {σ}_{Com} ( Z , θ )}{ⅆ Ω} ) = {k}^{′} \cdot {a}^{′} \cdot N ( Z , θ ) \qquad ( 9 )$$

where the small difference among the volumes and attenuation coefficients for the forward scattered and transmitted photons are described by parameters k′ and a′

$$\frac{{a}_{FS}}{( = {a}_{T} )} ,$$

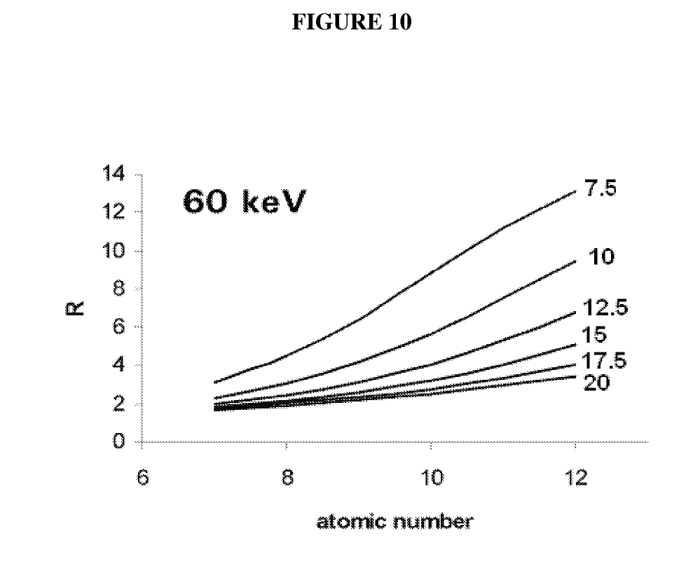

respectively. The quantity N(Z,θ) is a function of Z and θ for a fixed incident energy E. As in the case of R_{FB}, data on cross sections from the standard tables [41] can be used to determine theoretical values for the ratio R_{FS/T} (in arbitrary units). FIG. 10 shows theoretical values of R_{FS/T} as a function of Z for 7≦Z≦12, E=60 keV, and several choices of scattering angle θ. As in the case of the forward-backward ratio, the sensitivity of the forward-transmitted ratio increases with decreasing values of θ and E.

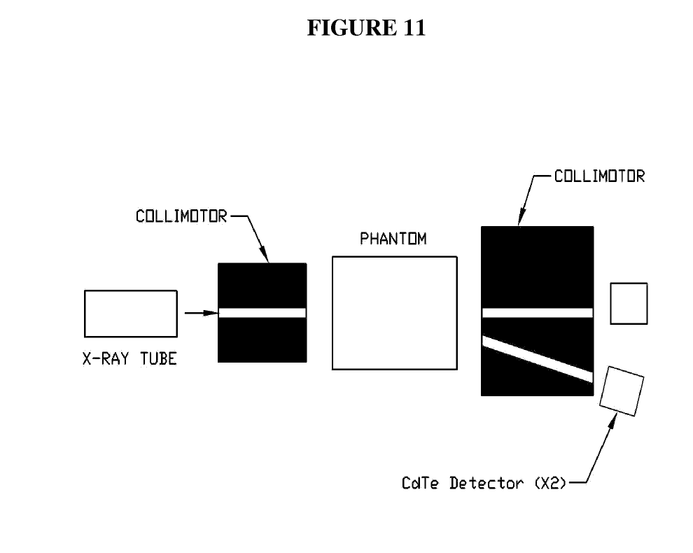

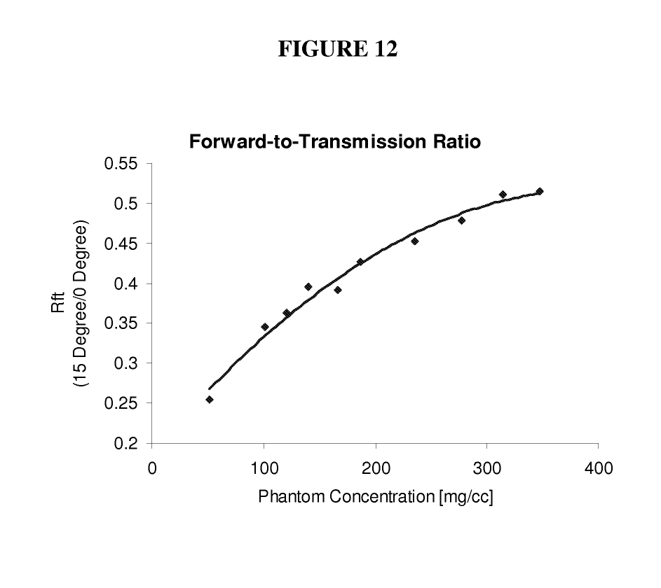

The relationship between density and the ratio of R_{FS/T} was investigated experimentally using the setup sketched in FIG. 11. The full spectra of the transmitted and 15° scattered radiation through our set of trabecular bone phantoms described above were recorded simultaneously using two CdTe detectors. The intensities in the spectral region defined by 55.8≦E≦60.5 keV were used to calculate R_{FS/T} from the measured intensities. FIG. 12 shows a plot of the measured R_{FS/T} values (the circles) versus the known densities of the 10 phantoms as well as a curve fit (to the 10 values of R_{FS/T}).

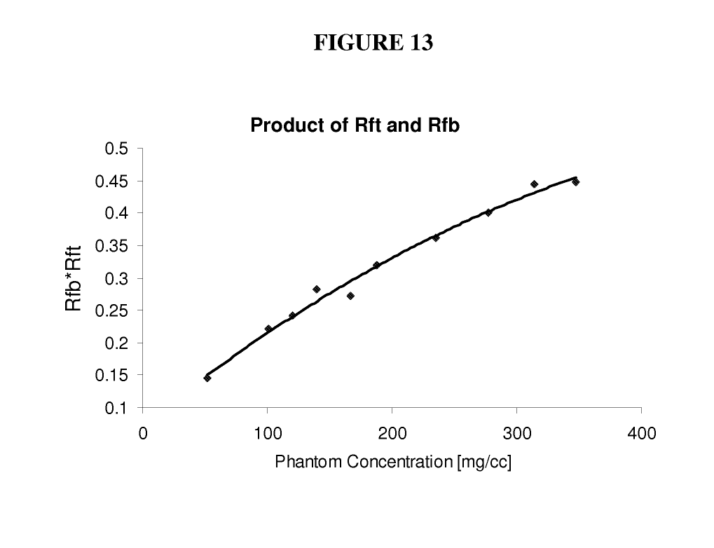

The above embodiments demonstrate that TBMD and BMD can be simply and inexpensively measured by the proposed FS-FB and FS-T detection methods using a low intensity and low peak energy X-ray tube and a relatively low cost solid state X-ray detector. It is evident from the experimental curves given in FIG. 13 that the product of the R_{FS/BS} and R_{FS/T} ratios yields a stronger functional dependence than either of the individual ratios, indicating that an enhanced sensitivity to BMD can be obtained using the product of the ratios. Since data can be simultaneously collected and analyzed for all three types of x-rays emerging from the irradiated volume; transmitted, forward scattered and backward scattered, all three ratios R_{FS/BS}, R_{FS/T}, and R_{FS/BS}xR_{FS/T} can be determined from the same data set and used for calibration, correlations, and estimates of accuracy and reproducibility.

Design and Methods Examples

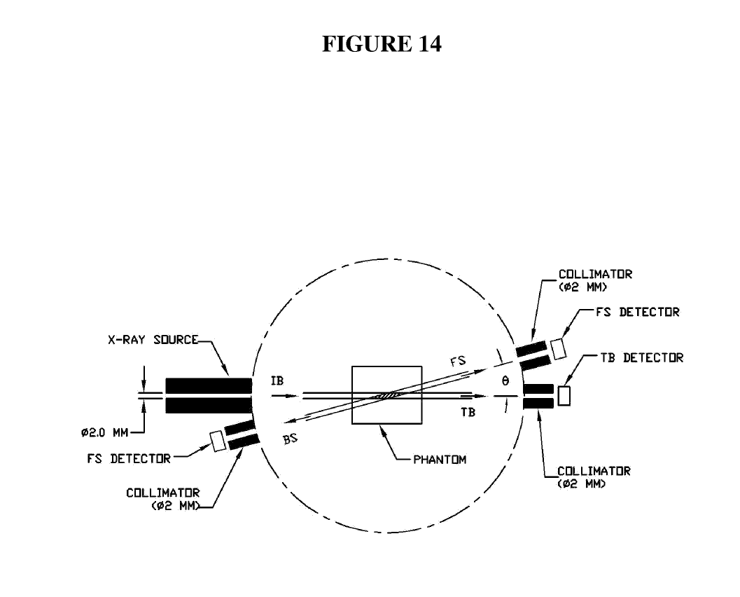

The general set-up for another embodiment is shown in FIG. 14 and consists of an X-ray tube, three strongly collimated (incident, scattered and transmitted) beams, one solid state detector associated with each type of radiation (for a total of three detectors), and a set of 10 composite phantoms made of bone ash and petrolatum [46] and one phantom with petrolatum exclusively. The phantoms with known TBMD ranging from 51.8 to 347.3 mg/cm³, and an 11^{th} phantom having a TBMD of 0 mg/cm³, are used as the scattering media. Since a narrow beam of X-rays is incident upon the target, the radiation scattered in the forward and backward directions at angles of θ and 180+θ, plus the transmitted radiation should be simultaneously collected. Additional detectors may be used in detecting transmitted radiation for a DEXA analysis to be compared with CCSR measurements.

Sensitivity and dosage are determined by the minimum detectable intensity of scattered radiations to obtain a desired accuracy. It is necessary to first find the optimal values of the critical and dominant parameters. Using the analytical models presented above, more theoretical simulations may be performed to characterize the scattering intensity as a function of E (incident energy) and θ (scattering angle) for 40≦θ≦120 keV and 10°≦θ≦30°. The corresponding experimental data will subsequently be collected using the experimental configuration of FIG. 14. In addition to experimental measurements and theoretical calculations of TBMD using the quantities outlined above including R_{FS/BS}, R_{FT/T}, and R_{FS/BS}×R_{FT/T}, the sensitivity may be evaluated from the minimal detectable signal-to-noise ratio (SNR) in order to evaluate possible improvements.

A stronger collimation system often results in a higher radiation dosage and a tradeoff must be made among improved collimation and decreased dosage. A collimator of diameter 2 mm may be employed witht the presen example that comprises a good approximation of the ROI volume to be used that is small enough to fit inside typical human bones at peripheral sites such as the calcaneous. The diameter of the collimators may be adjusted until a study of measurement sensitivity is determined. In order to maintain an ROI volume that approximates that of human bones we will likely impose the constraint that θ≧10°, since smaller angles will produce undesirable ROIs. Note that one of the distinguishing differences of the SAXS and technique of the present example is that SAXS is usually undertaken at θ≦5° [28-34].

Detection Systems

One aspect of the present example is the use of low cost but highly sensitive X-ray detectors for CCSR related measurements. A variety of counters including scintillation detectors may be used; including NaI and CdTe as well as proportional chambers, with respect to detection efficiency, energy resolution and noise characteristics. As in DEXA, the integrated intensity of scattered and transmitted radiation without separation of the coherent and Compton photons should be undertaken using the FS-T configuration (of FIG. 14) to evaluate the BMD data obtained using the integrated (total) number of counts in the spectral region of interest. In the FS-BS technique (of FIG. 14) it may be necessary to examine the spectrum. A careful choice of energy intervals is necessary to characterize and quantify the Compton component of the spectrum and its shift in peak energy relative to coherent component of the spectrum from the same incident energy region. A detector option for FS-BS measurements is now discussed in the following description of radiation dosage analysis.

Radiation Dosage Analysis

Radiation dosage in CCSR measurements is of concern because in the present embodiment, the proposed scattering techniques use a small solid angle for BMD measurements from a radiation field that scatters photons in all directions. Indeed, approximately 80% of the incident intensity may be scattered away. Typically, a DEXA device has a dose of 1-5 μSv while QCT's dosage ranges from ˜50 to several hundred μSv [52, 53]. Since the FS-BS and FS-T techniques of the present embodiment allow the use of different detection methods, dosages should be calculated independently and compared with DEXA and QCT.

In the forward scattering-to-backward scattering technique (FS-BS) the entire spectrum may be detected. The dosage of standard CCSR has been measured to be a couple hundred mrads [44], about one order of magnitude higher than QCT. The CCSR dosage is most accurately estimated from the number of counts that make up the coherent peak. The irradiated volume (the source of scattered radiation) in standard CCSR is about 5 cm³ [47]. For θ=15° and collimator diameters of 2 mm, the scattering volume is about one tenth of that used in standard CCSR. The width of the coherent peak from the radionuclide source used in standard CCSR may be limited by the spectroscopic width of the gamma line. If the source of radiation is bremsstrahlung with a continuous spectrum, the intensity of scattered radiation can be measured in a much broader spectral region in order to improve counting statistics. On the other hand, the width of spectral regions should be narrow enough to avoid the potential problem of beam hardening, requiring that counting rates be correspondingly increased usually by a factor of 2-5 to provide comparable statistics. In addition, standard CCSR uses coherent radiation scattered at high angles, up to 130° [42]. The intensity of 60 keV coherent radiation scattered at θ=15° for Z=10 may be more than 100 times higher than the intensity for θ=90°. This difference is even greater for smaller Z (for Z=7 and θ=15° the intensity may increase by a factor of 260 compared to that of θ=90°). Accordingly, the dosage for the FS-BS technique may be reduced by another order of magnitude from standard CCSR dose that shall bring the final dose of FS-BS down to the range equivalent to that of QCT, to a few hundred of μSv.

For the forward scattering-to-transmission technique (FS-T), the scenario is quite different. As in DEXA, FS-T may require that an integrated intensity to be calculated. For the higher energy portion of the transmitted spectrum in DEXA, the intensity is given by the following expression:
I_{T}I₀·T_{obj}^{T}·T_{det}^{T}·ε_{T} (10)

where T_{obj}^{T} is the object transmission coefficient and T_{det}^{T} is the transmission coefficient of the detector filter. In the dual keV DEXA technique, beam hardening is resolved by use of an intermediate filter between the high energy and low energy detectors, usually constructed out of Cu. The thickness of this filter depends on the detector design and can exceed 8 g/cm² in some cases [11]. As a result, only 2.5% of the incident intensity at 100 keV reaches the high energy detector. Even with such high losses, the dosage of DEXA is very low, approximately several μSv.

The intensity of the scattered radiation in FS-T at an angle θ can be calculated from the following formula:
Iₛ(θ)=I₀(P_{coh}(Zθ)+P_{Com}(Z,θ))Ω·T_{bs}·Tₐₛ·εₛ (11)

where I₀—is the intensity of the incident radiation

P_{coh}(Z,θ) and P_{Com}(Z,θ)—are the probabilities of emission of coherent and Compton radiation per unit solid angle

dΩ—the solid angle (bight) of the detector

T_{bs} and Tₐₛ—are transmission coefficients of the object before and after scattering, and

εₛ—is the detector efficiency.

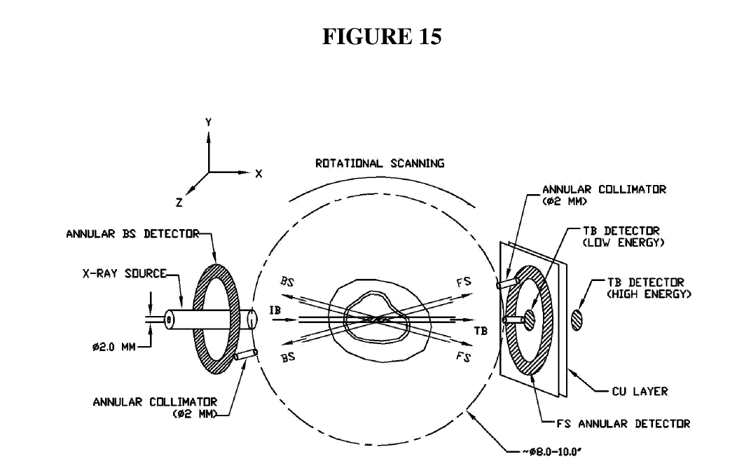

A small portion of the incident radiation is scattered elastically (without change of energy) in the forward direction. Using the standard diagnostic energies and average Z typical of trabecular bone, this fraction is of the order of 10⁻³. To reduce the dose in FS-T diagnostics by a factor of 10³, several major options are possible. One involves a detection system which doesn't have high inherent filtration as in DEXA. If the FS detector operates without filtration then dosage can be reduced by one order of magnitude (a factor of 10). Anpother option is to use an annular detection as outlined in the FIG. 15. In this case, scattering can be approximated to be axis-symmetric and to form a cone of opening angle θ (the scattering angle) if the scattering target is assumed to be symmetric and uniform. The use of this type of annular detection system can increase the detected intensity by a factor of two orders of magnitude (a factor of 100). Thus a total dose reduction of a factor of 10³ could be achieved without filtration using an annular system. Recent research in coherent tomography has demonstrated that better signal-to-noise ratios can be obtained for X-ray scattering in bone using a similar or lower radiation dosage than that of conventional projection/transmission imaging techniques [33, 34].

CCSR dosage estimates may be derived from previous data on conventional CCSR. With proper design and configuration optimization, aided by modern detector, electronics and computer technologies further improvements in sensitivity and reductions in radiation dosage are achieved by obtaining detailed intensity and spectral data on scattered and transmitted radiation under different conditions so that important elements, including detector type/size, photon counting statistics, source-detector distance, collimator apertures, X-ray energy, scattering angle, and detection, noise, and data acquisition requirements can be determined.

Attenuation and Accuracy Compensation

Attenuation must be addressed for quantitative determination of BMD using scattered radiation. In standard CCSR, both coherent and Compton photons travel through identical pathway to a single detector. However, a more complex issue is that the Compton component has a lower energy than the coherent segment (FIG. 8 shows the energy difference between 15° and 90° photons) and the attenuation coefficient varies with energy, although this affect has not been described in the literature. For the FS-BS and FS-T setups described above, each transmitted or scattered beam has a different source-target-detector path. In in-vivo applications bone geometry can be non-uniform and irregular, bone size will vary from patient to patient, and it will not be possible to accurately locate the ROI for each patient. Also the energy of backward scattering will be lower than that of forward scattering. Therefore each beam may yield a measured attenuation that deviates significantly from its real value. However corrections for the resulting errors can be made using a simple rotational mechanism and corresponding modifications for testing body and bone anomalies.

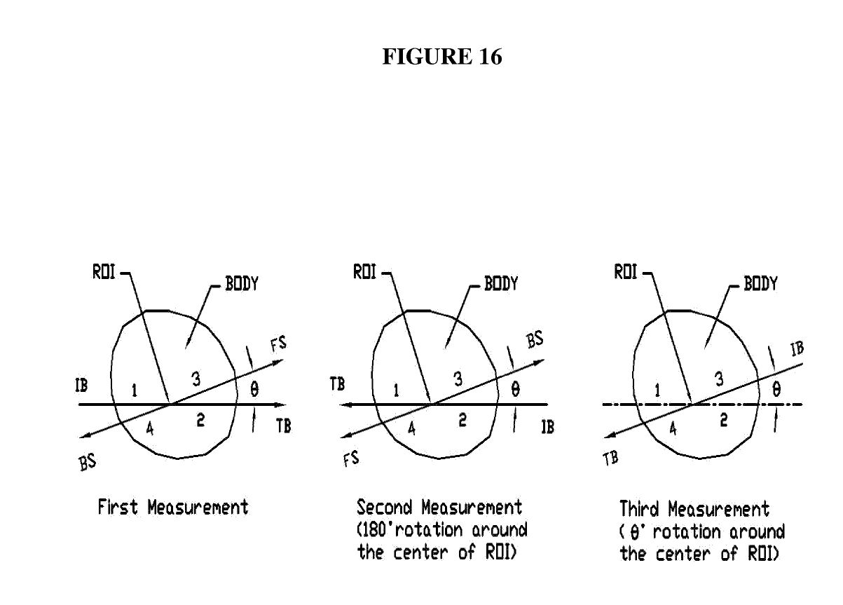

For example, FIGS. 4 and 16 depict an arbitrary arrangement of an incident X-ray beam interacting with a body comprised of bone, fat and issue. The ROI is situated inside the trabecular bone. The forward-scattered (FS) radiation has almost identical energy to that of the incident (I) and transmitted beams (T), denoted by E₀. The lower energy of the back scattered radiation (BS) is denoted by E_{B}. Three measurements, illustrated schematically in FIG. 16, are required to complete a cycle of the attenuation correction procedure. In each case, full spectra of scattered and transmitted radiation are recorded. Two equivalent versions of Equation 8 are obtained for the first two measurements which involve the same scattering volume and average BMD. Step 3 is only required for transmission data to solve for the unknown attenuation variable so that low X-ray intensity can be used to minimize radiation exposure. The product of the first two measurements can be written as:

$${R}_{FS / BS - 1} \times {R}_{FS / BS - 2} = kM ( Z , θ ) \frac{{a}_{1} ( {E}_{0} ) {a}_{3} ( {E}_{0} )}{{a}_{1} ( {E}_{0} ) {a}_{4} ( {E}_{B} )} \times kM ( Z , θ ) \frac{{a}_{2} ( {E}_{0} ) {a}_{4} ( {E}_{0} )}{{a}_{2} ( {E}_{0} ) {a}_{3} ( {E}_{B} )} = {k}^{2} {M}^{2} ( Z , θ ) \frac{{a}_{3} ( {E}_{0} ) {a}_{4} ( {E}_{0} )}{{a}_{3} ( {E}_{B} ) {a}_{4} ( {E}_{B} )} \qquad ( 12 )$$

where aᵢ(E₀) and aₖ(E_{B}) are a measure of the transmission factor or relative transparency at energies E₀ and E_{B} passing through distances i and k, and M(Z, θ) is the same function described in Equation 8. After canceling out the attenuation factors on the left hand side, the numerator contains factors for transmission of the beam of energy E₀ through path of 3-4, directly obtained from the spectrum measurements in step 3 and the denominator contains factors for backscatter of the beam of energy EB through path 3-4. It is notable that a₃(EB)a₄(EB) are not a directly measured but are related to a₃(Eo)a₄(Eo) in a function which can be independently deduced. This factor (a₃(E_{B})a₄(E_{B})) can be predetermined during the system design and is independent of the testing and clinical conditions.

Similarly, in the case of the forward scattering and transmission (FS-T) technique described above, in the energy region Eo, the product of the two measurements computed from Equation 8 is:

$${R}_{FS / T - 1} \times {R}_{FS / T - 2} = {k}^{′} N ( Z , θ ) \frac{{a}_{1} ( {E}_{0} ) {a}_{3} ( {E}_{0} )}{{a}_{1} ( {E}_{0} ) {a}_{2} ( {E}_{0} )} \times {k}^{′} N ( Z , θ ) \frac{{a}_{2} ( {E}_{0} ) {a}_{4} ( {E}_{0} )}{{a}_{1} ( {E}_{0} ) {a}_{2} ( {E}_{0} )} = {{k}^{′}}^{2} {N}^{2} ( Z , θ ) \frac{{a}_{3} ( {E}_{0} ) {a}_{4} ( {E}_{0} )}{{a}_{1} ( {E}_{0} ) {a}_{2} ( {E}_{0} )} \qquad ( 13 )$$

where aᵢ(E₀) is a measure the transmission factor at energy E₀ passing through a distance i. As in the case of the FS-BS technique the attenuation correction is simply a transmission factor for E₀ through the path of 3-4 relative to the path of 1-2, taken during the first/second and third measurements. It is notable that a simple distance correction may be sufficient for the FS-T method without rotational corrections if the shape of the object is known since the two components of the same energy travel through very similar path and distances that are distinguished only by the small angle θ.

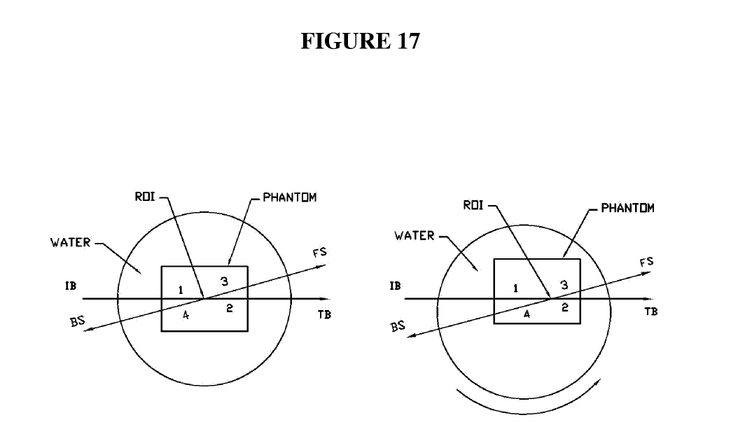

In the experiment described in FIG. 17 a phantom is immersed in water. A baseline measurement is made using a phantom with ideal geometry centered in a water-filled container. Please note that the energy difference has not been compensated even in this configuration with perfect incident geometry. Next the phantom and water container are reconfigured in an off-center configuration to simulate a different scattering pathway. Measurements are made using the full correction procedure. The data is subsequently collected and attenuation effects are analyzed for the new geometric arrangement.

The above is also valid in 3-D space if an annular detector is used. As such, the error due to attenuation can be fully corrected. Because multiple measurements result in a longer examination time and increased radiation exposure, one must evaluate the benefit of improved accuracy versus increased dosage, to determine if the benefit to risk ratio increases when the correction procedure is used.

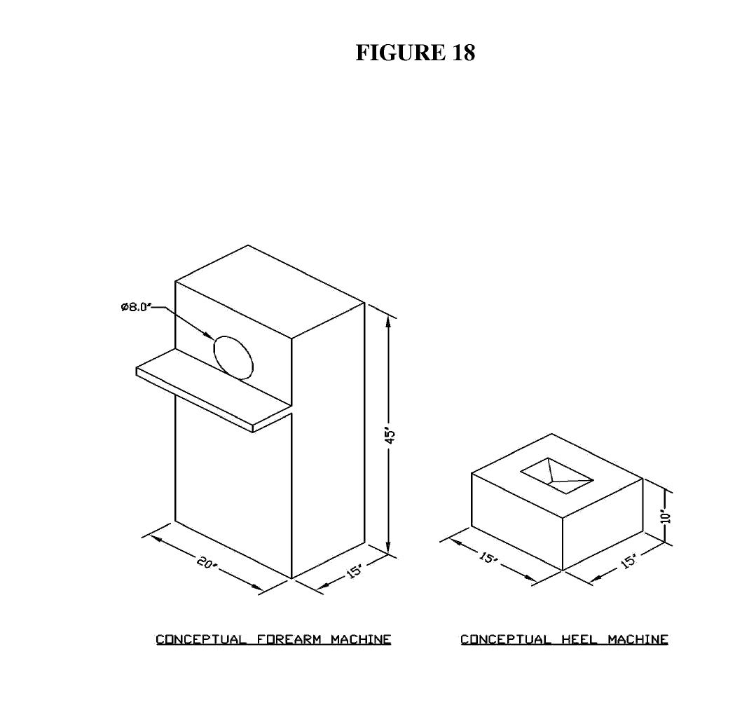

Referring to FIG. 18, an example of an in vivo application of the above apparatus and method is now described. In order to optimize sensitivity and accuracy the skeletal site must be properly selected. For example, one embodiment is a device to study the peripheral skeleton, similar to those used by small clinics to study the forearm, knee, or heel (calcaneous). Clinical data which shows that tests of the heel using quantitative ultrasound are as useful as an assessment of the hip or of the spine in making a diagnosis of osteoporosis and in predicting of fracture risk [2].

The embodiments set forth herein describe an apparauts and method of scattering technology that offers significant advantages over existing bone densitometry techniques. The forward-to-backward scattering (FS-BS) method is highly sensitive and accurate without the necessity of frequent calibration, but may yield a relatively high radiation dosage that is equivalent to that of QCT. The forward scattering-to-transmission (FS-T) method yields a much lower radiation dosage, within the range of DEXA, but may require some type of calibration. In contrast to DEXA, both FS-BS and FS-T yield a true volumetric BMD for trabecular bone rather than a projected areal density, which is particularly important for cases in which there is a wide variety of bone dimensions such as a general clinic and in some disease conditions. Further, a device and method are provided that are comparable to DEXA and have the advantage of providing a true volumetric density.

### LIST OF REFERENCES

1. “Bone Health and Osteoporosis”. A Report of the Surgeon General (2004).

2. “Osteoporosis Prevention, Diagnosis, and Therapy”, NIH Consensus Statement, Volume 17, Number 1, Mar. 27-29, 2000.

3. Cummings S. R., Bates D, Black D. M., “Clinical use of bone densitometry: Scientific Review”, JAMA 2002 Oct. 16; 288(15):1889-1897.

4. Cummings S. R., Bates D, Black D. M., “Clinical use of bone densitometry: Clinical Applications”, JAMA 2002 Oct. 16;288(15):1898-1900.

5. The website of International Society for Clinical Densitometry, www.iscd.org

6. Gillian Klucas, “Trends in bone density and breast cancer screening”, Medical Imaging, Vol. 16, No. 5, May 2001.

7. Jon Placide, MD, and Mark G. Martens, MD, “Comparing Screening Methods for Osteoporosis”, Current Women's Health Reports 2003, 3:207-210.

8. R. Brunadaer, et al “Radiologic Bone Assessment in the Evaluation of Osteoporosis”, American Family Physician, Apr. 1, 2002, v. 65, n. 7, p. 1357-1364.

9. M. A. Greenfield, “Current Status of Physical Measurements of the Skeleton,” Med. Phys., 19, 6, 1349-1357, (1992).

10. J. A. Sorenson, P. R. Duke and S. W. Smith, “Simulation studies of dual-energy x-ray absorptiometry”, Medical Physics 16, 75-81 (1989).

11. D. P. Charkraborty and G. T. Barnes, “Bone mineral densitometry with x-ray and radionuclide sources: A theoretical comparison”, Medical Physics 18, 978-985 (1991).

12. H. H. Boltin, “Analytic and quantitative exposition of patient specific systematic inaccuracies inherent in phantom DXA-derived in vivo BMD measurements”, Medical Physics 25, 139-151 (1998)

13. G. M. Blake, D. B. McKeeney, S.C. Chaya, P. J. Ryan and I. Fogelman, “A Dual energy x-ray absorptiometry: The effects of beam hardening on bone density measurements”, Medical Physics 19, 459-466 (1992).

14. H. H. Boltin, “A new perspective of the effects of body weight and body fat mass on DXA measured in vivo bone mineral density”, Osteoporosis Int. 8, 514 (1998)

15. D. T. Baran, K. G. Faulkner, H. K. Genant, P. D. Miller, R. Pacifici, “Diagnosis and Management of Osteoporosis. Guidelines for the Utilization of Bone Densitometry”, Calcified Tissue International 61:433-440, 1997

16. Jergas M, Breitenseher M, Gluer CC; Yu W, Genant HK, “Estimates of volumetric bone density from projectional measurements improve the discriminatory capability of dual X-ray absorptiometry”, J Bone Miner Res 1995 Jul;10(7):1101-10.

17. S. P. Niesen, N. Kolthoff, 0. Barenholdt, B. Kristensen, B. Abrahamsen, A. P. Hermann, C. Brot, “Diagnosis of Osteoporosis by Planar Bone Densitometry: Can Body Size be Disregarded?”, The British J of Radiology, 71 (1998), 934-943.

18. M. M. Goodsit: “Beam hardening errors in post processing dual energy quantitative computed tomography”, Medical Physics 22, 1039-1047 (1995)

19. P. M. Joseph and C. Ruth, “A method for simultaneous correction of spectrum hardening artifacts in CT images containing bone and iodine”, Medical Physics, Oct. 1997, vol. 24, No. 10, pp. 1629-1634.

20. Chye Hwang Yan, Whalen, R. T., Beaupre, G. S., Yen, S. Y., Napel, S., “Reconstruction algorithm ford polychromatic CT imaging: application to beam hardening correction”, IEEE Transactions on Medical Imaging, Jan. 2000, IEEE, vol. 19, No. 1, pp. 1-11.

21. R. Hodgskinson, C. F. Njeh, J. D. Currey and C. M. Langton: “The ability of ultrasound velocity to predict the stiffness of cancellous bone in vitro”, Bone 21, 183-190 (1997)

22. C. F. Njeh, T. Fuerst, E. Diessel and H. K. Genant: “Is quantitative ultrasound dependent on bone structure? A reflection”, Osteoporosis Int. 12, 1-15, 9, 2001

23. M. Krmar, S. Shukla, and K. Ganezer, “New Possibilities for the CCSR technique in bone diagnostics”, AAPM 2004 oral presentation MO-D-315-5, Med. Phys. 31, Issue (6), 1748, (2004).

24. US Preventive Service Task Force, “Screening for osteoporosis in postmenopausal women: recommendations and rationale”, Ann Intern Med, 2002; 137: 526-528

25. H. H. Bolotin, “Inaccuracies inherent in dual-energy X-ray absorptiometry in vivo bone mineral densitometry may flaw osteopenic/osteoporotic interpretations and mislead assessment of antiresorptive therapy effectiveness”, Bone. 2001 May, 28(5): 548-55

26. Tom V Sanchez, “A Focus on Accuracy in Dual-energy X-ray Absorptiometry Measurements”, Business briefing: European Pharmacotherapy 2003.

27. P. Ravaud, J. L. Reny, B. Giraudeau, R. Porcher, M. Dougados, and C. Roux, “Individual Smallest Detectable Difference in Bone Mineral Density Measurements”, J. of Bone and Mineral Res., August 1999, Volume 14, Number 8, Page 1449

28. G. J. Royle and R. D. Speller, “Quantitative diffraction analysis of bone and marrow volumes in excised femoral head amples”, Physics in Medicine & Biology, 40, 1487-98, 1995.

29. R. D. Speller and G. J. Royle, “Tissue characterization using low angle x-ray scattering”, Journal of X-ray Science & Technology, 3, 77-84, 1992.

30. Robert Speller, “Tissue analysis using x-ray scattering”, X-Ray Spectrometry, Volume 28, Issue 4, Pages 224-250, 1999.

31. G. J. Royle and R. D. Speller, “Low angle x-ray scattering for bone tissue analysis”, Physics in Medicine & Biology, 36, 383-9, 1991.

32. G. J. Royle and R. D. Speller, “Small Angle X-ray Scattering of Trabecular Bone”, Physica Medica, 6, 279-281, 1990.

33. D. L. Batchelar, W. Dabrowski and I. A. Cunningham, “Tomographic imaging of bone composition using coherently scattered x rays”, Medical Imaging 2000: Physics of Medical Imaging, Eds J. Dobbins III and J. Boone, Proceedings of the SPIE 3977, 353-361, 2000.

34. M. S. Westmore, A. Fenster, and I. A. Cunningham, “Angular-dependent coherent scatter measured with a diagnostic x-ray image intensifier-based imaging system”, Medical Physics 23,723-733, 1996.

35. P. Puumalainen, A. Uimarihuhta, E. Alhava, and H. Olkkonen, “A new photon scattering method for bone mineral density measurement”, Radiology, 120, 723-724, (1976).

36. McCullough, “Photon attenuation in computed tomography”, Medical Physics 2, 307-320 (1975)

37. A. Karellas, I Leichter, J. D. Craven, M. A. Greenfield, “Characterization of tissue via coherent-to-Compton scattering ratio: sensitivity considerations,” Med. Phys., 10(5) 605-609 (1983)

38. J. J. Hubbell, “Photon mass attenuation coefficients and energy absorption coefficients from 1 keV to 20 MeV,” Int. J. Appl. Radiat. Isot. 33, 1269-1290 (1982).

39. G. D. Guttmann and M. M. Goodsitt, “The effect of fat on the coherent-to-Compton scattering ratio in the calcaneous: A computational analysis”, Medical Physics, Volume 22, Issue 8, pp. 1229-1234, August 1995.

40. G. E. Gigante, and S. Sciuti, “A large-angle coherent/Compton scattering method for measurement in vitro of trabecular bone mineral concentration,” Med. Phys., 12(3), 321, (1985).

41. J. H. Hubbell, W. J. Veigele, E. A. Briggs, P. T. Brown, D. T. Cromer, R. J. Howerton, “Atomic form factors, incoherent scattering functions, and photon scattering cross sections,” J. Phys. Chem. Ref. Data 4, 471-538 (1975)

42. S. A. Kerr, K. Kouris, C. E. Weber, and T. J. Kennett, “Coherent Scattering and the Assessment of Mineral Concentration in Trabecular Bone,” Phys. Med. Biol., 25, 1043-1047, (1980).

43. G. E. Gigante, and S. Sciuti, “A large-angle coherent/Compton scattering method for measurement in vitro of trabecular bone mineral concentration,” Med. Phys., 12(3), 321, (1985).

44. J. T. Stalp and R. B. Mazes, “Determination of bone density by coherent-Compton scattering,” Med. Phys., 7(6) 723-726 (1980)

45. Shih-Shen Ling, S. Rustugi, A. Karellas, J.D. Craven, J. S. Whiting, M. A. Greenfield and R. Stern, “The measurement of trabecular bone mineral density using coherent and Compton scattered photons in vitro,” Med. Phys., 9(2) 208-215 (1982)

46. I. Leichter, A. Karellas, S.S. Shukla, J. L. Looper, J. D. Craven and A. M. Greenfield, “Quantitative assessment of bone mineral by photon scattering: calibration considerations,” Med. Phys., 12(4) 466-468 (1985)

47. S. S. Shukla, I. Leichter, A. Karellas, J. P. Craven, M. A. Greenfield, “Trabecular bone mineral density measurement in vivo: use of coherent to Compton scattered photons in the calcaneous,” Radiology 158(3) 695-697 (1986)

48. S. S. Shukla, M. Y. Leu, T. Tigle, B. Krutoff, J. D. Craven, M. A. Greenfield, “A study of homogeneity of the trabecular bone mineral density in the calcaneous,” Med. Phys., 14(4) 687-690 (1987)

49. S. S. Shukla, M. Leu, J. D. Craven, M. A. Greenfield, “Clinical results in measurement of trabecular bone mineral density in the calcaneous using coherent-to-Compton scatter ratio method,” Radiology 161(P) 312 (1986)

50. S. S. Shukla, A. Karellas, I. Leichter, J. D. Craven, M. A. Greenfield, “Quantitative assessment of bone mineral by photon scattering: Accuracy and precision consideration,” Med. Phys., 12(4) 447-448 (1985)

51. J. H. Hubbell, W. J. Veigele, E. A. Briggs, P. T. Brown, D. T. Cromer, R. J. Howerton, “Atomic form factors, incoherent scattering functions, and photon scattering cross sections,” J. Phys. Chem. Ref. Data 4, 471-538 (1975)

52. C F Njeh, K Apple, D H Temperton and C M Boivin, “Radiological assessment of a new bone densitometer—the Lunar EXPERT,” The British Journal of Radiology, 1996, Vol 69, Issue 820 335-340.

53. W Huda and R L Morin, “Patient doses in bone mineral densitometry,” The British Journal of Radiology, 1996, Vol 69, Issue 821 422-425.

Papers and patents listed in the disclosure are expressly incorporated by reference in their entirety. It is to be understood that the description, specific examples, and figures, while indicating preferred embodiments, are given by way of illustration and exemplification and are not intended to limit the scope of the present invention. Various changes and modifications within the present invention will become apparent to the skilled artisan from the disclosure contained herein and may be made without departing from the spirit of the present invention. Therefore, the spirit and scope of the appended claims should not be limited to the description of the preferred versions contained herein.

1. A method of measuring bone density comprising:
irradiating a volume to be analyzed;
for x-rays emerging from the irradiated volume, detecting at least two of transmitted x-rays, forward scattered x-rays and backward scattered x-rays; and
analyzing at least two of the transmitted x-rays, the forward scattered x-rays, or the backward scattered x-rays to determine a bone mineral density by determining at least one of a ratio of the forward scattered x-rays to the backward scattered x-rays, a ratio of the forward scattered x-rays to the transmitted x-rays, or the product of the ratio of the forward scattered x-rays to the backward scattered x-rays and the ratio of the forward scattered x-rays to the transmitted x-rays.

2. The method of claim 1 wherein the step of detecting comprises:
detecting the forward scattered x-rays at an angle θ from the transmitted x-rays and the backward scattered x-rays at an angle θ+ about 180°, where θ is less than about 20°.

3. The method of claim 2 wherein the angle θ is less than about 15°.

4. The method of claim 2 wherein the angle θ is greater than 5° and less than about 15°.

5. A method of measuring bone density comprising:
irradiating a volume to be analyzed;
for x-rays emerging from the irradiated volume, detecting at least two of transmitted x-rays, forward scattered x-rays and backward scattered x-rays; and
analyzing at least two of the transmitted x-rays, the forward scattered x-rays, or the backward scattered x-rays to determine a density by normalizing the intensity of the forward scattered x-rays and the backward scattered x-rays.

6. A method for attenuation compensation comprising:
(1) irradiating a volume to be analyzed with first incident beam;
(2) for x-rays emerging from the irradiated volume, detecting at least two of transmitted x-rays, forward scattered x-rays at an angle 0 from the transmitted x-rays and backward scattered x-rays at an angle 0 plus about 180° from the transmitted x-rays; and
(3) analyzing at least two of the transmitted x-rays, the forward scattered x-rays, or the backward scattered x-rays to determine a bone mineral density by determining at least one of a ratio of the forward scattered x-rays to the backward scattered x-rays, a ratio of the forward scattered x-rays to the transmitted x-rays, or the product of the ratio of the forward scattered x-rays to the backward scattered x-rays and the ratio of the forward scattered x-rays to the transmitted x-rays;
(4) irradiating the volume to be analyzed with a second incident beam wherein the second incident beam is 180° from the first incident beam, and/or irradiating the volume to be analyzed with a third incident beam wherein the third incident beam is 180° plus or minus angle 0 from the first incident beam; and
(5) repeating steps (2) and (3) for the second incident beam and/or the third incident beam.

7. The method of claim 6 wherein θ is less than about 20°.

8. The method of claim 7 wherein θ is less than about 15°.

9. The method of claim 7 wherein θ is greater than 5° and less than about 15°.
